(19) United States
(12) Patent Application Publication
(10) Pub. No.: US 2007/0116880 A1
(43) Pub. Date: May 24, 2007

(54) Method for coating vehicle bodies and parts thereof with rust-preventive ionomeric coatings

(76) Inventors: Albert Gordon Anderson, Wilmington, DE (US); Walter Mahler, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/284,871

(22) Filed: Nov. 22, 2005

(51) Int. Cl. B05D 1/36; B05D 3/02

(52) U.S. Cl. 427/372.2; 427/402

(57) ABSTRACT

The present invention is directed to a method for coating car or truck bodies, or part thereof, with a rust-preventive ionomer coating composition as the car or truck body is being conveyed along the assembly line as at the vehicle assembly plant. The method of the present invention is used as a replacement for the electrodeposition priming process used today at vehicle assembly plants.

### TECHNICAL FIELD

This invention relates to a method for coating vehicle bodies, such as car and truck bodies and parts thereof, with rust-preventive ionomeric coatings to provide corrosion protected bodies having good smoothness, appearance, and corrosion resistance.

### BACKGROUND OF THE INVENTION

Electrodeposition of rust-preventive primers on metal automotive substrates is widely used in the automotive industry. In this process, a conductive article, such as an autobody or an auto part, is immersed in a bath of an electrodepositable coating composition comprising an aqueous emulsion of a film forming polymer and the article acts as an electrode in the electrodeposition process. A high voltage electric current is then passed between the article and a counter-electrode in electrical contact with the coating composition until a coating of a desired thickness is deposited on the article. In a typical cathodic electrocoating process, the article to be coated is the cathode and the counter-electrode is the anode.

After the electrodeposition process is complete, the resulting coated article is removed from the bath and is rinsed with deionized water and then cured typically in an oven at sufficient temperature to form a crosslinked finish on the article. Once the electrodeposition rust-preventive primer is applied to the automotive substrate, the vehicle is then top coated with a multi-layer automotive exterior finish to provide chip resistance properties and an attractive aesthetic appearance such as gloss and distinctness of image.

One disadvantage associated with conventional electrodeposition processes is that coating defects tend to form on the surface of the coated article, such as pinholes and cracks, which can compromise the corrosion protective properties of the electrodeposited film and produce other deleterious effects such as a rough film surface. The high voltage baths required in electrodeposition coating processes use up large amounts of electricity and are also expensive to maintain. Furthermore, the multiple deionized water rinses are undesirable, as they present significant waste handling and water treatment problems.

Accordingly, there is a desire to eliminate the electrocoating process altogether and find new coating methods and compositions which can replace the electrodeposition process, while still maintaining the desired coating properties for automotive rust-preventive primer finishes such as a high degree of corrosion resistance and paint adhesion to both underlying rust-preventive pretreatments on the metal surface and to paint applied thereover during exterior automotive finishing operations.

Various ionomeric coating compositions comprising aqueous dispersions of ionomer resins made from ion-neutralized ethylene-acrylic acid or ethylene-methacrylic acid copolymers have been proposed for rust-preventive treatment of metal surfaces, for example, as disclosed in JP 2000-198949 A2 to Akimoto et al., WO 00/50473 A1 to Nakata, et al., and U.S. Pat. No. 6,458,897 to Tokita, et al. issued Oct. 1, 2002. However, none of these have been used to treat entire vehicle bodies being conveyed along a vehicle assembly line, especially using the electrocoat tank emptied of electrocoat composition as the holding/dip tank for these ionomer resin dispersions.

Diverse properties are required for a coating formed from an ionomer resin dispersion in order for it to be a suitable commercial replacement for an electrocoat bath. Good edge protection, bath stability and uniformity and corrosion resistance, water impermeability, film smoothness and ease of use are desired to produce a high performance rust-preventive coating of automotive quality. The present invention provides a method of coating ionomer resin dispersions onto a vehicle body as it is being conveyed on a continuously moving automotive assembly line in the vehicle manufacturer's plant, without adversely impacting upon the operation of the coating operation and the level of corrosion protection when compared to a standard electropriming process.

The method of the present invention is capable of forming a rust-preventive primer finish on vehicle bodies, such as car and truck bodies, or parts thereof, that meets the high performance requirements of automotive finishes. This method is therefore a suitable commercial replacement for conventional electrodeposition primers and electopriming processes used nowadays in automotive assembly plants. The process of the present invention can be applied to typical car body steel such as galvanized steel, but since it is robust enough, it can also be applied to untreated metal to provide direct contact corrosion protection, which provides substantial savings to the automakers, since most vehicle bodies today are constructed of costly Zn plated (galvanized) steel everywhere except the roof area.

### SUMMARY OF THE INVENTION

A method is provided for coating a vehicle body, such as a car or truck body, or part thereof, with a rust-preventive ionomeric coating composition, as the vehicle is being conveyed on a vehicle assembly line during its original manufacture. The coating method is preferably used as a replacement for electrocoating car and truck bodies. The method comprises:

(a) applying to at least one surface of an automotive substrate, such as a vehicle body or part thereof, a coating liquid comprising an aqueous dispersion of an ionomer resin neutralized with ammonium ions and optionally divalent or polyvalent metal ions;

(b) flash drying or baking said coating liquid on the substrate to form an initial rust-preventive primer layer;

(c) applying over said initial rust-preventative primer layer, a metal salt solution of a divalent or polyvalent metal, preferably zinc or aluminum;

(d) flash drying or baking said coated substrate to form a hardened rust-preventive primer coating layer; and

(e) optionally, applying over said hardened rust-preventive primer layer, a primer surfacer and/or an automotive topcoat finish such as a basecoat/clearcoat finish;

wherein the automotive substrate is, preferably, in continuous movement throughout the primer paint application process along a vehicle assembly line.

Preferably, the ionomer resin coating liquid is housed in the existing electrocoat tank that has been emptied of electrocoating composition and is being used as a complete replacement for the standard automotive electrodeposition coating composition. The old electrocoating tank is preferably used as a coating dip tank for the new ionomer resin. The tank is preferably stripped of electrodes and applied voltage and is preferably operated as a non-electrophoretic coating process. The metal salt solution is preferably housed in an existing water rinse tank previously positioned after the electrocoating tank in the conventional electrodeposition process.

Treated articles such as vehicle bodies or parts thereof treated with the same, also form part of this invention.

The ionomer resin dispersion employed as the first coating liquid preferably comprises ethylene-acrylic acid or methacrylic acid copolymer having an acid content of 5-40 weight percent neutralized with ammonium ions, and water as the volatile liquid carrier, and the metal salt solution used as the second coating liquid is preferably comprised of at least one divalent metal cation selected from the group consisting of alkaline earth metals and Zn, and water as the volatile liquid carrier.

### BRIEF DESCRIPTION OF THE DRAWINGS

The forgoing summary, as well as the following detailed description of the preferred embodiments, will be better understood when read in conjunction with the appended drawings, in which:

FIG. 1 is a schematic diagram of an exemplary process according to the present invention for applying an ionomer resin coating composition to an automotive substrate on a continuously moving assembly line during vehicle manufacture.

### DETAILED DESCRIPTION OF THE PREFERRED EMBODIMENTS

In this disclosure, a number of terms and abbreviations are used. The following definitions are provided.

“Ionomer” or “ionomeric resins” are polymers or copolymers of ethylene and acrylic or methacrylic acid that have optionally been partially or completely neutralized with a base, such as a metal hydroxide or oxide or acetate, ammonium hydroxide, or amines. The resulting polymer is capable of forming or behaving as though crosslinks are formed between polymer chains under curing conditions, creating tough flexible films.

“Copolymer” means polymers containing two or more monomers.

All “molecular weights” disclosed herein are determined by gel permeation chromatography “GPC” using polystyrene as the standard.

A method according to the present invention for applying a rust-preventive ionomer coating liquid to an automotive substrate to form a rust-preventive coating layer thereon as part of an automotive coating process will now be discussed with reference to an exemplary continuous automotive coating process described in detail below. By “continuous process” is meant that the substrate is in continuous movement along an assembly line. However, it is to be understood that this exemplary continuous coating process is provided simply as one example of a process in which the invention can be practiced and the invention should not be considered as limited thereto. One skilled in the art would understand that the present invention could also be used, for example, in non-continuous, e.g., semi-continuous or indexing coating processes, or batch coating processes. Additionally, while the following discussion is directed primarily to coating automotive bodies, it is to be understood that the invention could be practiced on any automotive substrate at any point along the coating line or off-line.

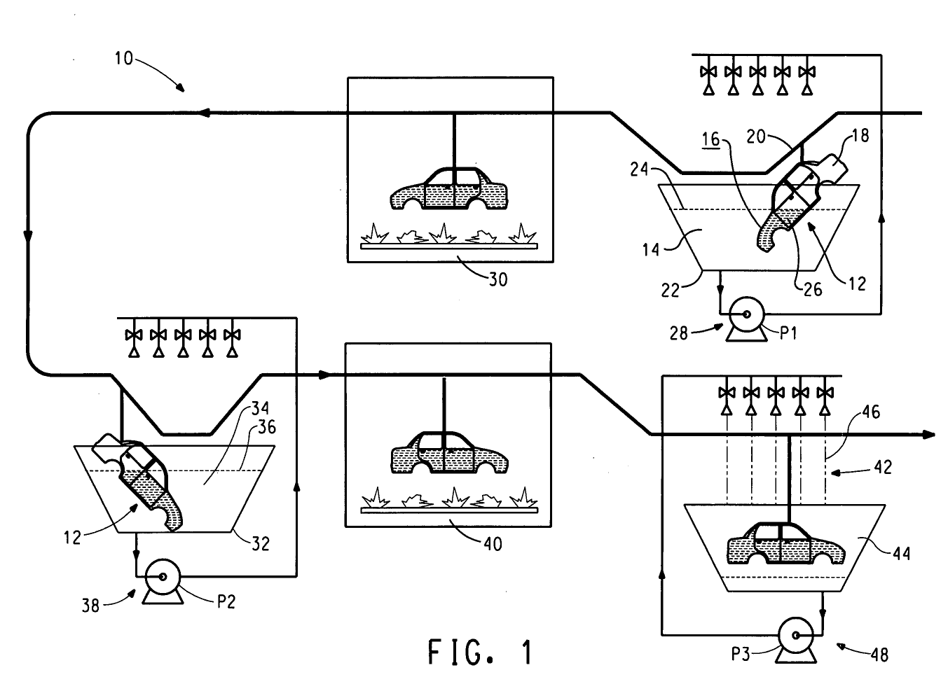

Referring now to FIG. 1, there is shown a schematic diagram of a portion of an exemplary continuous automotive coating process (indicated generally as 10) for applying a rust-preventive primer over one or more surfaces of an automotive substrate, for rinsing the coated substrate, if desired, with one or more rinsing compositions, and for flash drying or baking the substrate in a continuous oven.

Useful substrates that can be coated include those formed from metallic materials, for example ferrous metals such as iron, steel, and alloys thereof, non-ferrous metals such as aluminum, zinc, magnesium and alloys thereof, and combinations thereof. Preferably, the substrate is formed from cold-rolled steel, electrogalvanized steel such as hot-dipped electrogalvanized steel, aluminum or magnesium.

The substrates can be used as components to fabricate automotive vehicles, including but not limited to automobiles, trucks, and tractors. The substrates can have any shape, e.g., in the form of automotive body components, such as bodies (frames), hoods, doors, fenders, bumpers and/or trim, for automotive vehicles. A coating system incorporating the concepts of the present invention first will be discussed generally in the context of coating a metallic automobile body. One skilled in the art would understand that a coating process incorporating the present invention also is useful for coating other automotive as well as non-automotive components.

The substrate is typically first cleaned to remove grease, dirt, or other extraneous matters. This is typically done by employing conventional cleaning procedures and materials. Such materials include mild or strong alkaline cleaners, such as those commercially available and conventionally used in metal treatment processes. Examples of alkaline cleaners include Chemkleen 163 and Chemkleen 177, both of which are available from PPG Industries, Pretreatment and Specialty Products. Such cleaners are generally followed and/or preceded by water rinse(s). Optionally, the metal surface may be rinsed with an aqueous acidic solution after cleaning with the alkaline cleaner and before contact with a subsequent coating composition. Examples of rinse solutions include mild or strong acidic cleaners, such as the dilute nitric acid solutions commercially available and conventionally used in metal treatment processes.

The metal substrate may also optionally be phosphated. Suitable phosphate conversion coating compositions may be any of those known in the art. Examples include zinc phosphate, iron phosphate, manganese phosphate, calcium phosphate, magnesium phosphate, cobalt phosphate, zinc-iron phosphate, zinc-manganese phosphate, zinc-calcium phosphate, and layers of other types, which may contain one or more multi-valent cations. Phosphating compositions are known to those skilled in the art and are described, for example, in U.S. Pat. Nos. 4,941,930; 5,238,506; and 5,653,790.

The substrate can also be contacted with one or more conventional passivating compositions to improve corrosion resistance. Such passivating compositions are typically dispersed or dissolved in a carrier medium, usually an aqueous medium. The passivating composition may be applied to the metal substrate by any known application technique, such as by dipping or immersion, spraying, intermittent spraying, dipping followed by spraying, spraying followed by dipping, brushing, or by roll-coating. An exemplary passivating composition is described in U.S. Pat. No. 6,217,674.

Referring now to FIG. 1, in the first portion 12 of the rust-preventive primer coating process 10, a coating liquid in the form of a liquid ionomer resin coating composition 14 is applied to a surface 16 of an automobile body 18 in a first step 20. The coating composition 14 can be applied, for example, by dipping the automobile body 18 into a container or bath 22 containing the liquid ionomer resin coating composition 14. Preferably, the container being used is the existing electrodeposition coating dip tank located along the assembly line at a vehicle assembly plant.

As indicated above, the existing electrocoating tank will not be used for electrodeposition in view of the present invention. Instead, it is used as the dip tank 22 for the ionomer resin coating composition which serves herein as a replacement or substitute for the electrodeposition coating composition and process. The liquid ionomer resin coating composition 14 has a top surface 24, the location of which top surface 24 in the bath 22 may vary between a maximum level and a minimum level depending upon the quantity of coating composition 14 in the bath 22 and whether the automobile body 18 is in or out of the bath 22. The liquid ionomer resin coating composition 14 can be applied to the surface 16 of the automobile body 18 by any suitable dip coating process well known to those skilled in the art.

In the primer coating process of the present invention, the electrically conductive anode or cathode (not shown) previously used in the electrodeposition process will preferably be turned off in the tank and essentially no voltage will be passed between this electrode and its counter-electrode (the electrically conductive surface 16 of the automobile body 18) to deposit the coating film on the automobile body. Instead, in the present invention, the automobile body merely enters the dip tank 22 and following contact with the liquid ionomer resin coating composition, an adherent film 26 of the coating composition 14 is deposited on the automobile body 18. The conditions under which film deposition is conducted can be varied depending on the environmental conditions at the assembly plant, the nature of the liquid coating materials, and the desired final film thickness of the adherent coating film, as will be apparent to those skilled in the art. It is generally desired to keep the automobile body 18 in the dip tank 22 for about 1 to 300 seconds, more preferably about 1 to 60 seconds, at a bath temperature of 18 to 60° C., at atmospheric pressure.

Of course, the rust-preventive ionomer treatment can be conducted by any other known manner such as spray, curtain, flow coater, roll coater, brush coating, and the like. In automotive applications, the dipping method, as described above, is generally preferred.

Generally, any type of conventional ionomer resin coating composition can be used in the practice of the present invention. Preferably, the ionomer resin coating composition 14 comprises an aqueous dispersion of ionomer resin in water. The ionomer resin coating composition can also be dispersed in an aqueous medium which can include an admixture of water with coalescing solvents, if desired. The ionomer resin coating composition is also preferably supplied as a one-component system with all ingredients dispersed and at least partially neutralized in aqueous medium prior to incorporation into the dip tank.

The ionomer resin coating composition used herein generally comprises an aqueous dispersion of one or more film-forming ionomer resins, such as an ethylene-unsaturated carboxylic acid copolymer, and one or more neutralizing agents therefore. The amount of film-forming material in the composition generally ranges from about 5 to 50 weight percent on a basis of total weight solids of the composition.

As for the components of the aqueous dispersion, the ionomer resin is typically a polymer comprising a polymeric main chain mainly consisting of hydrocarbon, and having carboxyl groups at side chains, wherein at least a part of the carboxyl groups is neutralized with cationic neutralizing agents. Preferably, the ionomer resin employed in the present invention is an ethylene-unsaturated carboxylic acid copolymer (“ethylene-acid copolymer”), comprising a partially neutralized product obtained by neutralizing at least a part of the carboxyl groups contained in the copolymer with either polyvalent metal cations, alkali metal cations, ammonium ions, or a mixture of any of the above.

The ethylene-unsaturated carboxylic acid copolymer that constitutes the main skeleton of the ionomer resin may be a random copolymer of ethylene and unsaturated carboxylic acid or a graft copolymer in which unsaturated carboxylic acid is graft bonded to the main chain comprising polyethylene. In particular, the ethylene-unsaturated carboxylic acid random copolymer is preferable. Further, this ethylene-unsaturated carboxylic acid copolymer may contain one kind of unsaturated carboxylic acid only, or two kinds or more of unsaturated carboxylic acids.

The unsaturated carboxylic acid that is the component of the ethylene-unsaturated carboxylic acid copolymer includes an unsaturated carboxylic acid having 3-8 carbon atoms or the like. Specific examples of the unsaturated carboxylic acid having 3-8 carbon atoms include acrylic acid, methacrylic acid, maleic acid, fumaric acid, itaconic acid, crotonic acid, isocrotonic acid, citraconic acid, allylsuccinic acid, mesaconic acid, glutaconic acid, nadic acid, methyinadic acid, tetrahydrophthalic acid, and methylhexahydrophthalic acid. Of those, acrylic acid and methacrylic acid are preferable from the standpoint of film-forming property.

Further, the ethylene-unsaturated carboxylic acid copolymer may contain a third component in the main skeleton such as a softening monomer in addition to ethylene and the unsaturated carboxylic acid. This third component includes unsaturated carboxylic acid esters such as methyl(meth)acrylate, ethyl(meth)acrylate and isobutyl(meth)acrylate, and vinyl esters such as vinyl acetate. If these monomers are included, it is generally desirable for the content to be set in the range of 20 wt % or less, preferably 10 wt % or less, since larger amounts tend to cause the melting point of a coating film to fall and the heat resistance to be unacceptable. Preferably, the ethylene acid copolymer is a dipolymer (no third comonomer).

As for the ethylene-unsaturated carboxylic acid copolymer, when considering the feasibility of manufacture of an aqueous dispersion, the dispersion stability and the physical properties of the coating film obtained with the aqueous dispersion, it is generally desirable for the ethylene-unsaturated carboxylic acid copolymer to have an unsaturated carboxylic acid content of 5-40 wt. %, preferably 10-35 wt %, and more preferably 15-25 wt. %. In the case of using a copolymer containing an unsaturated carboxylic acid in an amount that is less than the above-mentioned range, it is difficult to obtain a composition having good dispersion stability. In the case of using a copolymer containing an unsaturated carboxylic acid in an amount more than the above-mentioned range, the waterproofness (imperviousness to water) and mechanical strength of the coated film are reduced.

At least a part of the carboxyl groups on the ethylene-unsaturated carboxylic acid copolymer is neutralized with a base such as a metal hydroxide or oxide, ammonia, ammonium hydroxide, or amines, or any mixtures thereof, to form crosslinks comprising association of carboxylic acid anions with various metal cations, and ammonium ions. To obtain a coating film especially excellent in water resistance and film quality, it is more desirable to use a mixture of divalent or polyvalent metal cations and ammonium ions as the neutralizing agent. The metal ions which remain in the film provide the desired corrosion resistance to the coating formed therefrom. The ammonium ions evanesce as ammonia on heating and thus provide the desired water impermeability, especially in comparison to alkali metal ions.

As for divalent metal cations that can be used herein, alkaline earth metals, such as Mg and Ca, or Zn are preferred. As for polyvalent metal cations that can be used, Al is generally preferred. Of those, the ionomer resins having Zn is preferable in the point that the production is easy.

Since the metal cations remain in the final film, it is preferred to discuss levels of neutralization in terms of the metal ion. As will be appreciated by one skilled in the art, the preferred degree of neutralization by the metal, i.e., the preferred ratio of metal ion to carboxylic acid anion, of course will depend on the ethylene-acid copolymers and the ions employed and the properties desired. However, the preferred proportion of carboxyl groups neutralized with metal cations to all of carboxyl groups that the ethylene-unsaturated carboxylic acid copolymer has on the side chain, that is, degree of neutralization by the metal, is generally about 10-100%, and preferably 20-80%, and most preferably 25-50%, so that a coating having excellent corrosion resistance is obtained.

In addition, it should be understood that compounds containing above metal cations, if used alone in the bath 22, would cause the aqueous ionomer resin dispersion to coagulate, and prevent the formation of a quality film. Therefore, to avoid coagulation of the ionomer dispersion, it is generally preferred in the process of the present invention, to use a two-coat or two-dip process, whereby two sequential baths are used, namely bath 22 as mentioned above and another bath 32 which is further described hereinbelow. It is preferred that the first bath 22 contain the aqueous ionomer resin dispersion formed from an ammoniacal dispersion that optionally may contain one or more of the above metal ions, preferably in the range of 10 to 90 mole ratio with respect to the carboxylic acid groups. After the substrate is coated with the above ammoniacal dispersion, in the second coating step, it is subsequently coated, preferably by dip coating, with a metal salt solution contained in the second bath 32 to form the final hardened coating film. The metal used in the second bath may be the same or different from the metal that is optionally used in the first bath. Moreover, any mono, di, or polyvalent metal may be used in the second bath provide that the metal is stable in water solution.

The production of ionomer resins for use herein in the first bath can be conducted according to various methods well known in the art, for example, a method of copolymerizing ethylene, unsaturated carboxylic acid, and a third component used according to the need, by a high pressure radical polymerization method, and neutralizing carboxyl groups of the ethylene-unsaturated carboxylic acid copolymer obtained with a cationic compound; or a method of graft polymerizing unsaturated carboxylic acid onto polyethylene, and neutralizing carboxyl groups of the graft copolymer obtained with a cationic compound. Further, this production may be conducted by supplying predetermined components into an extruder and melt kneading to conduct reaction, or may be conducted in water or an appropriate organic solvent.

Rather than preparing the ethylene-unsaturated carboxylic acid copolymer, Nucrel®, which is a poly(ethylene-co-methacrylic acid) copolymer, sold by DuPont, Wilmington, Del., can be used as the starting material. This material is typically sold pre-dispersed in ammonia water.

To make the ammoniacal dispersion therefrom which is used as the initial coating in the first bath, a compound having the desired ammonium ions which can be used to neutralize the resin is ammonia (NH₃) or aqueous ammonia (which is also referred to herein as “ammonium hydroxide” or “ammonia water”).

As for the components that can be used to make the first or second bath, compounds having desired polyvalent metal cations which can be used include oxides or hydroxides thereof or water-soluble salts such as the acetates, sulfates and nitrates of zinc, calcium, magnesium, or aluminum.

More specifically, the initial coating composition used in the first bath can be made by introducing ionomer resin, aqueous ammonia (ammonium hydroxide), and the like and water into a vessel, then stirring or shaking the mixture at a temperature above the melting temperature of the ionomer resin, typically about 100-200° C., for a sufficient time to heat, melt and uniformly disperse the ionomer resin, preferably about 10 minutes to 2 hours. The dispersion for the first bath is also preferably made with an excess amount of aqueous ammonia (i.e., using an amount of ammonia in excess of the amount that would be needed to neutralize the carboxylic acid groups). The mole ratio of ammonia to carboxylic acid is generally in the range of about 2 to about 6. The metal salt hardening solution of the second bath is made by dissolving any of the metal salts described above, such as zinc acetate, calcium acetate, and the like in water.

A suitable aqueous dispersion for rust-preventive coating of automotive bodies that can be used in the first bath comprises an aqueous dispersion of ethylene-acid copolymer having an acid content of 18-30 wt. % and 75-600 mole % ammonia based on the carboxyl groups of copolymer. A suitable metal salt hardening solution that can be used in the second bath comprises 25-50 mole % metal cations, preferably zinc cations, based on the carboxyl groups of copolymer.

A suitable aqueous dispersion for rust-preventive coating also preferably has its average diameter of dispersed particles in the range of about 0.1 μm or less, and preferably 0.05 μm or less and its solid content concentration in the range of 10-45 wt %, and preferably 15-35 wt %, and more preferably 15-30 wt. %.

A suitable aqueous dispersion typically also has a pH of 7 or more and a viscosity of about 30-2,000 mPa·s, and particularly about 50-1,500 mPa·s, at the time of application for good workability.

Various other additives can be blended into the initial dispersion to provide additional coating attributes, depending on need, within the range that the object of the present invention is not impaired. For example, various other film-forming and/or crosslinking resins such as water-soluble polyester polyols, acrylics, and water- soluble covalent curing agents such as amino resins and the like. The water-soluble amino resin is used in particular to improve strength of the coating, and examples thereof include water-soluble melamine resin, hexamethoxymelamine, methylolated benzoguanamine resins and methylolated urea resins. Examples of the other components include organic and inorganic thickeners to adjust viscosity, surface active agents to improve stability, water-soluble polyvalent or monovalent metal salts and other rust-preventive assistants, vapor phase corrosion inhibitors, mildew proofing agents, fungicides, biocides, ultraviolet absorbers, heat stabilizers, foaming agents, rheology control agents, pigments, fillers, and extenders. In addition to the forgoing materials, in order to obtain a coating film with sufficient water resistance for automotive applications (i.e., impervious to agents which can cause corrosion of metal), it is generally desired to include at least one non-water soluble, vapor phase corrosion inhibitor such as dicyclohexylamine in the dispersion.

The thickness of the ultimate coating applied to the substrate can vary based upon such factors as the type of substrate and intended use of the substrate, i.e., the environment in which the substrate is to be placed and the nature of the contacting materials. Generally, the coating is applied such that the final thickness of the coating formed on the substrate ranges from about 0.1-20 μm, and more preferably to coat in a thickness of 0.3-10 μm.

Referring again to FIG. 1, the initial coating composition 14 in the bath 22 can be recycled in conventional manner, such as by a recycling system 28 having a pump P1 that prevents the solids of the coating composition from settling to the bottom of the bath 22. Further, the temperature of the coating composition 14 may be controlled by use of a heat exchanger (not shown) in flow communication with the bath 22 in any conventional manner, such as through pipes or conduits.

The initial coating composition 14 from the bath 22 also may be in flow communication with a conventional ultrafiltration system (not shown) to remove soluble impurities and the filtered material recycled to the ionomer bath 22. In the ultrafiltration system, the coating composition 14 flows over a membrane permeable to water and small particles, e.g., those less than about 1,000 Mw, such as salts. The ultrafiltrate or “permeate”, i.e., the portion of the coating composition which passes through the membrane, can be used in further subsequent rinsing operations (if employed) and a portion of the permeate, e.g., about 20 weight percent, may be discarded. The “non-permeate” portion of the coating composition is directed back into the bath 22, e.g., through one or more conduits or pipes.

After conveying from the ionomer coating bath 22, the coated automobile body 18 is preferably exposed to air to permit excess deposited coating composition to drain from the interior cavities and surfaces of the automobile body 18 back into the bath 22.

After coating the rust-preventive ionomer coating composition on a substrate, the agent may be spontaneously dried (i.e., flash dried under ambient or slightly elevated temperature conditions, preferably at an air temperature ranging from about 10° C. to about 40° C.), but it is preferable to conduct baking in a conventional continuous oven 30 typically located after the ionomer resin dip tank along the automotive assembly line. The oven baking temperature is about 60-250° C. The coated automotive body 18 is preferably conveyed to the continuous oven 30 and heated in the above temperature range for about 1 second to 30 minutes to drive off the volatile components such that a rust-preventive layer comprising a coating having good corrosion resistance can be formed.

After baking step 30 and sufficient cooling, preferably down to room temperature, the coated automobile body 18 is conveyed preferably to a second container or bath 32 containing the metal salt solution 34 to further harden the ionomer coating that was applied in the first step 20. Preferably, the container being used as the coating dip tank in this step is the existing electrodeposition coating rinse tank located along the assembly line at a vehicle assembly plant, which has been converted to a dip tank. As previously discussed, various ionic salt solutions can be used in this step, although those containing Zn, Ca or Al are generally preferred. These can be simple salts such as the acetate, sulfate or nitrate. The metal salt solution 34 has a top surface 36, the location of which top surface 36 in the bath 32 may vary between a maximum level and a minimum level depending upon the quantity of salt solution 34 in the bath 32 and whether the automobile body 18 is in or out of the bath 32. The metal salt solution is preferably applied by dipping the automobile body 18 into the second container or bath 32 containing the liquid metal salt solution to form a hardened rust-preventive ionomer coating film on the surface of the vehicle.

As with the application of the ionomer dispersion, any suitable dip coating process well known to those skilled in the art can be used. Of course, the metal salt solution treatment can also be conducted by any other known manner such as spray, curtain, flow coater, roll coater, brush coating, and the like. In automotive applications, the dipping method, as described above, is generally preferred.

Then, when the coated automobile body is conveyed to the second tank 32 which contains the metal salt solution, the second bath 32 is maintained at a temperature that allows the metal to diffuse into the film and crosslink with the remaining acid functionality in the polymer film. Generally, the second bath temperature is preferably maintained about 70 to 90° C., at atmospheric pressure. It is generally desired to keep the automobile body 18 in the second dip tank 32 for about 1 to 40 minutes. This produces an extremely tough hardened coating that results in a significant increase in corrosion resistance and chip resistance of the coating, in comparison to the one dip method described above, and to ionomeric coatings not subjected to a second dip.

The metal salt solution in the bath 32 can also be recycled in conventional manner, such as by a recycling system 38 having a pump P2 that prevents the solids of the coating composition from settling to the bottom of the bath 32. Further, the temperature of the salt solution 34 may be controlled by use of a heat exchanger (not shown) in flow communication with the bath 32 in any conventional manner, such as through pipes or conduits.

The metal salt solution 34 in the second bath 32 can also be in flow communication with a conventional ultrafiltration system (not shown) to remove soluble impurities and the filtered material recycled to the salt bath 32. In the ultrafiltration system, the salt solution 34 flows over a membrane permeable to water and small particles, e.g., those less than about 1,000 Mw, such as salts. The ultrafiltrate or “permeate”, i.e., the portion of the salt solution which passes through the membrane, can be used in further subsequent rinsing operations (if employed) and a portion of the permeate, e.g., about 20 weight percent, may be discarded. The “non-permeate” portion of the salt solution is directed back into the bath 32, e.g., through one or more conduits or pipes.

After conveying from the metal salt solution bath 32, the coated automobile body 18 is preferably exposed to air to permit excess deposited coating composition to drain from the interior cavities and surfaces of the automobile body 18 back into the bath 32.

After applying the metal salt on the automotive substrate, the agent may be spontaneously dried (i.e., flash dried under ambient or slightly elevated temperature conditions, preferably at an air temperature ranging from about 10° C. to about 40° C.), but it is preferable to conduct baking in a conventional continuous oven 40 typically located after the ionomer resin dip tank along the automotive assembly line. The oven baking temperature is about 60-250° C. The coated automotive body 18 is preferably conveyed to the continuous oven 40 and heated in the above temperature range for about 1 second to 30 minutes to drive off the volatile components such that a rust-preventive layer comprising a coating having good corrosion resistance can be formed.

The thickness of the rust- preventive coating layer formed on the substrate is appropriately selected according to the purpose of use of rust-preventive treated metal products, rust-preventive treating agent used, kind, thickness or the like of a over coat paint, and the like, and is not particularly limited thereto. Generally, in order to exhibit sufficient rust-preventive ability without causing breakage in the rust-preventive layer when drying after coating the rust-preventive treating agent, it is preferable to coat in a thickness of about 0.3 to 2.5 mils (7 to 60 μm), preferably 0.5 to 1.5 mils (12 to 36 μm).

The coated automobile body can then be conveyed to a rinsing process 42 for removing unattached metals and other impurities and any excess coating from the surface. The rinsing process 42 can include one or more spray and/or dip rinsing operations, as desired. Preferably, the coated automobile is conveyed over a spray rinse tank 44 where a rinsing composition 46, preferably deionized or tap water, is spray applied to the coated surfaces of the automobile body 18. The excess spray composition is permitted to drain into the rinse tank below for recirculation, e.g., by a recirculation system 48 having a recirculation pump P3, for subsequent spray operation. The coated automobile body is then conveyed out of the spray rinse area and the excess rinsing composition is permitted to drain back into the tank for reuse. The rinse tank used may be one of the other existing rinse tanks located along the vehicle assembly line tat a vehicle assembly plant which had been previously used in a conventional electrodeposition process.

The process of the invention may also include a subsequent cooling step (not shown) to cool the finish to ambient temperatures before the vehicle is further worked on during its manufacture.

The rust-preventive coating layer thus formed on the automobile body has excellent corrosion resistance and also good adhesion to an over coat paint, such as an automotive primer, filler or basecoat paint.

The rust-preventive coating method of the present invention is also especially useful over unplated metal, which is particularly desirable in the automotive industry when the metal is used to construct vehicle bodies, such as car and truck bodies.

In the rust-preventive treatment method of the present invention, after the rust-preventive primer coating layer is dried, it is traditionally overcoated or topcoated with a primer surfacer to provide a smooth film free of surface imperfections over which an automotive topcoat finish such as a basecoat/clearcoat finish can be applied.

The overcoat paint that is coated on the rust-preventive coating layer formed herein can be any automotive primer surfacer, filler or colored basecoat paint or basecoat/clearcoat paint. The nature of the primer surfacer, filler, or basecoat or basecoat/clearcoat composition employed in the method of the present invention is in no way critical. Any of a wide variety of commercially available automotive primer surfacer, fillers, basecoats, clearcoats may be employed in the present invention.

Typically, a primer-surfacer is next applied (not shown) to smooth the surface and provide a thick enough coating to permit sanding to a smooth, flat finish, and then baked. Then a top-coat system (not shown) is applied, sometimes as a single colored coat, more often now as a pigmented basecoat with solid color or flake pigments followed by a transparent protective clear coat, to protect and preserve the attractive aesthetic qualities of the finish on the vehicle even on prolonged exposure to the environment or weathering.

It has become customary, particularly in the auto industry, to apply a clear topcoat over the basecoat by means of a “wet-on-wet” application, i.e., the clear coat is applied to the basecoat without curing or completely drying the basecoat. The coated substrate is then heated for a predetermined time period to allow simultaneous curing of the base and clear coats.

Conventional coating methods such as spraying, electrostatic spraying, high rotational electrostatic bells, and the like, can be used to apply any of these three overcoatings. The preferred techniques for applying all three coatings are air atomized spraying with or without electrostatic enhancement, and high speed rotary atomizing electrostatic bells, since these techniques are typically employed in modern automobile and truck assembly plants.

When the primer surfacer coating material is applied to automotive bodies according to the present invention, any of the above techniques can be used.

The primer-surfacer coating material preferably forms a dry coated layer having a thickness of about 0.3 to 2.5 mils (7 to 60 μm), preferably 0.5 to 1.5 mils (12 to 36 μm), but it may vary according to the intended use.

The primer after application is typically flash dried at ambient temperatures and then baked in an oven 100-150° C. for about 15-30 minutes to form a cured primer surfacer layer on the substrate.

After the primer surfacer layer is formed on the automobile body, the layer may be cooled and sanded as desired. Then colored base coating material which may contain solid color, metallic flake, pearlescent and/or other effect pigments and a transparent clear coating material are the typically applied in the wet-on-wet manner to form a base coated layer and a clear coated layer.

The base coating material may be applied, like the primer surfacer coating material, with using air-electrostatic spray coating or a rotary atomizing electrostatic bell so as to have a dry thickness of 0.1 to 1.6 mils (3 to 40 μm). The basecoating is typically flash dried for a short period at ambient or slightly elevated temperatures before the automobile body is clearcoated.

The clear coated material is then applied on the base coated layer, for the purpose of smoothing roughness or glittering which occurs due to the presence of luster color pigment and for protecting a surface of the base coated layer. The clear coated material may be applied, like the base coating material, with using the rotary atomizing electrostatic bells.

The clear coated layer is preferably formed so as to have a dry thickness of about 1.0 to 3.0 mils (25-75 μm).

The basecoat and clearcoat obtained as described above are then cured simultaneously in an oven 100-150° C. for about 15-30 minutes to form a desired multi-layer finish on the automobile body.

The process of the invention may also include a subsequent cooling step (not shown) to cool the finish to ambient temperatures before the vehicle is further worked on during its manufacture.

The overall thickness of the dried and cured composite multi-layer finish is generally about 40-150 μm (1.5-6 mils) and preferably 60-100 μm (2.5-4 mils).

The rust-preventive treated automobile body obtained by the rust-preventive coating method of the present invention contains a rust-preventive layer having excellent water resistance and rust-preventive property, and therefore can suitably be used as parts for automobiles.

Coatings formed from the method of this invention have excellent rust-preventive properties and provide high level of adhesion to treated or untreated metals and are tough, flexible, stone-chip resistant, and are relatively impermeable to moisture and other corrosive agents, and can provide rust preventive coatings having properties desirable for automotive finishes.

The following Examples illustrate the invention. All parts and percentages are on a weight basis unless otherwise indicated.

### EXAMPLE 1

### Preparation of Rust-Preventive Treated Metal Plate

Cold rolled steel panels (3″×5″×032″, alloy: APR10288 C, available from ACT Laboratories, Inc., Hillsdale Mich.), were washed with acetone and deionized water and then air-dried. A dispersion of Nucrel® ionomer resin was prepared by diluting 1500 ml of 25% w/w Nucrel Michem Prime® 4983R (ethylene/21% acrylic acid copolymer at 25% solids in ammonia water available from Michelman Inc, Cincinnati, Ohio) to 12.5% w/w with 1500 ml of deionized water to obtain a 12.5% dispersion. The diluted dispersion was allowed to stand at room temperature for 1 hour to remove air bubbles. Then 21 cleaned steel panels were dipped in the diluted dispersion and then baked in an oven at 90° C. for 10 minutes. The panels were divided into 3 groups of 7 each. One group was dipped in aqueous 5% w/w solution of zinc acetate at 90° C. for 10 minutes. Another group was dipped in aqueous 5% w/w calcium acetate solution at 90° C. for 10 minutes. The last group was not treated with a post-dip.

### Test Results

Corrosion resistance was determined according to test method ASTM B117. The panels were subjected to 330 hours of a salt spray chamber according to ASTM B117. The 7 panels that were not post-dipped displayed extensive rusting. The panels that had been post-dipped showed a few small rust spots, which is a significant improvement in corrosion resistance.

Various other modifications, alterations, additions or substitutions of the components of the processes and compositions of this invention will be apparent to those skilled in the art without departing from the spirit and scope of this invention. This invention is not limited by the illustrative embodiments set forth herein, but rather is defined by the following claims.

We claim:

1. A coating method for applying a rust-preventive primer coating to an automotive substrate comprising:
(a) applying to at least one surface of an automotive substrate, such as a vehicle body or part thereof, a coating liquid comprising an aqueous dispersion of an ionomer resin neutralized with ammonium ions and optionally divalent or polyvalent metal ions;
(b) flash drying or baking said coating liquid on the substrate to form an initial rust-preventive primer layer;
(c) applying over said initial rust-preventative primer layer, a metal salt solution of a divalent or polyvalent metal;
(d) flash drying or baking said coated substrate to form a further hardened rust-preventive primer coating layer at temperatures between about 60° C. and 250° C.; and
(e) optionally, applying over said hardened rust-preventive primer layer, a primer surfacer and/or an automotive topcoat finish such as a basecoat/clearcoat finish.

2. The method according to claim 1 wherein the substrate is a car or truck body or part thereof.

3. The method of claim 1 wherein the automotive substrate is in continuous movement throughout the primer paint application process steps (a)-(d) as it travels along an automotive assembly line.

4. The method according to claim 1 wherein the metal coating liquid in step (a) is an aqueous dispersion of an ionomer resin is free of metal cation ions.

5. The method according to claim 4 wherein the metal salt solution comprises a salt solution of a divalent metal selected from the group consisting of Zn and Ca.

6. The method according to claim 5 wherein the ionomer resin is an ethylene-unsaturated carboxylic acid copolymer having an acid content of 10-35 wt %.

7. The method according to claim 5 wherein the ionomer resin is an ethylene-acrylic or methacrylic acid copolymer having an acid content of 10-35 wt %.

8. The method according to claim 6 wherein the divalent metal ion is selected from Zn.

9. The method according to claim 8 wherein the dispersion has a solids content of 10 to 45 wt %.

10. The method according to claim 5 wherein the dispersion further contains a non-water-soluble vapor phase corrosion inhibitor.

11. The method according to claim 1 wherein the metal coating liquid in step (a) is an aqueous dispersion of an ionomer resin partially neutralized by a mixture of ammonia and one or more divalent metal ions.

12. The method according to claim 5 wherein the solution temperature is between 70° C. and 90° C.

13. The method according to claim 5 wherein the surface is rinsed with water after the final bake.

14. A rust-preventive treated automotive substrate coated by the method of claim 1.

15. A rust-preventive treated car or truck body substrate coated by the method of claim 1.
